(19) United States
(12) Patent Application Publication
(10) Pub. No.: US 2003/0036912 A1
(43) Pub. Date: Feb. 20, 2003

(54) Computerized tax transaction system

(76) Inventors: Thu Dang Sobotta, Lawrenceville, GA (US); Dung Nguyen, Clarkston, GA (US)

Correspondence Address: Ms. Thu Dang Sobotta, 492 Leggett Oaks Lane, Lawrenceville, GA, 30043, US

(21) Appl. No.: 09/930,823

(22) Filed: Aug. 15, 2001

(51) Int. Cl. G06F 17/60

(52) U.S. Cl. 705/1

(57) ABSTRACT

A system processes data intended to be entered into a pre-printed form, where the pre-printed form has a plurality of data entry blanks occupying predefined positions on the pre-printed form. The system performs the following: displaying a graphical replica of the pre-printed form; displaying a plurality of data fields on the graphical replica, the data fields being positioned in the same relative positions to each other as the plurality of blanks on the pre-printed form; accepting data into the data fields; formatting the data in accordance with one or more specified data formats; and storing the data in a data management system.

### COPYRIGHT RIGHTS

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF INVENTION

The present invention relates to a computerized tax transaction system.

As regular as the cycles of the sun and the moon, every business and individual in the U.S. must file tax information with the government. Due to the widespread proliferation of computers, tax return preparation has become increasingly automated. Several computer programs are available for individual taxpayers to compute their federal income tax liability and generate completed tax returns (such as TurboTax from Intuit, Inc.). Also, U.S. Pat. No. 6,202,052, issued to Miller on Mar. 13, 2001 describes a “Fully-automated system for tax reporting, payment and refund.”

For many or most U.S. individual taxpayers, computation of income tax liability is generally a routine matter of collecting the relevant data, processing it, reflecting the data and ultimate calculations on the proper form or forms, and transmitting or otherwise sending the forms to the relevant taxing authorities. This trend is being aided by taxing authorities that have increasingly automated the tax collecting and return filing process. The U.S. Internal Revenue Service (“IRS”) permits in certain situations the electronic filing of tax returns and the payment and refund of income taxes through electronic money transfers.

However, despite these technological advances, the potential for fully-automated tax reporting has not yet been realized for several reasons. First, at present, it is still necessary for individuals and other taxpayers to collect and save hard copies of, or otherwise record, all of the data and other information needed to compute their tax liability. This information includes: IRS Forms W-2 from their employers; IRS Forms 1099 from their banks; each mutual fund in which interests are held, each broker in respect of dividends, interest and gross brokerage proceeds, and other persons from whom payments are received; IRS Forms 1098 in respect of residential mortgage interest paid and canceled checks or other acknowledgments from charitable organizations. This is typically done on an annual basis with W-2 and 1099 forms, and on a quarterly basis with 941 forms. An employer is required to furnish a completed Form W-2 (copies B, C, and 2) to each employee showing their compensation and tax withholding amounts for the calendar year by January 31 of the next year. The employer may choose to “furnish” the completed W-2 in a manner other than mailing, but mailing a properly addressed form on or before the due date meets the “furnish requirement.”

In the years that have passed since the original Federal W-2 form was first introduced, many states have enacted income tax withholding programs with procedures similar to those of the Internal Revenue Service. At the outset, a close copy of the federal form was used for state reporting. In the past few years, a carbon copy of the federal form, with state captions, has become accepted procedure. Today, most employers use a combination Federal-State W-2 Form modeled after the Official IRS form. The W-2 Forms have been designed to be read by Optical Scanning (OCR) equipment This is the reason for Part 1 (SSA Copy) being much different from the other parts. Part 1 is perforated every 11″. This Part 1, Copy A, is submitted to the Federal Government in sheets of two forms (11″) to be optically read by the Social Security Administration. Every 11″ sheet consists of two separate forms without a perforation in between All the remaining parts in the set are perforated every form, or every 5.5″, and the entire page of Copy A is submitted, even if one of the two forms is blank or voided.

As a general rule, for reporting in a state with no state or local income taxes, a 4-part, straight federal form is sufficient. Distribution of the set is as follows:

Copy A—For Social Security Administration (Employer Copy)

Copy B—To be filed with Employee's Federal Tax Return (Employee Copy)

Copy C—Employee File Copy

Copy D—Employer File Copy

A 6-Part Form has the regular parts plus a city or state return for the employer and one for the employee to file with his tax return. Thus, there are three employer copies and three employee copies. This is the most widely used form. An 8-Part Form is used where forms must be prepared for federal, state and city withholding tax and where both the state and city require the employee as well as the employer to file a copy. This is the exception rather than the rule inasmuch as most local or municipal ordinances require only the employer to submit a form. Notable examples are certain cities in Michigan, Pennsylvania, and Ohio which require a special employee copy for a total of 8. For example, Detroit, Cleveland and Pittsburgh are jurisdictions requiring the employee to file a city copy of the W-2 with his city tax return.

Additionally, the regulations under section 6011(e)(2)(A) of the Internal Revenue Code provide mandatory filing of various information returns on magnetic media if the quantity is more than a certain threshold. The forms affected are Forms 1042S, 1098, 5498, 8027, W-2G, W-2 and all the forms in the 1099 series. The regulations require all employers and other persons paying money who expect to file 250 or more of Forms W-2 or 1099 returns to file Copy A, the federal copy, not on paper, but on some type of magnetic media or filed electronically directly with the IRS. The regulations provide that these information forms must be filed on magnetic media unless (1) other person is filing less than the threshold quantity, or (2) the person or company is granted a waiver by the IRS. Filers who are required to submit their information returns on magnetic media may submit their documents by electronic filing instead, using a computer and a modem. Filers who submit their information returns electronically, by Feb. 28, 20XX, are considered to have satisfied the requirements for magnetic media filing. Copy A returns for both Forms W-2 and 1099 can now be filed on magnetic media using: 2″ magnetic tape, IBM 3480/3490 or AS400 compatible tape cartridges; 54″ or 32″ diskettes; or they can be filed electronically. Failure to file a return on magnetic media when required to do so would be treated as a failure to file the return The IRS/SSA encourages magnetic media or electronic filing even if not required to do so.

As can be seen, the process for preparing and submitting W-2 and 1099 forms is complex and prone to data entry errors.

### SUMMARY

A system processes data intended to be entered into a pre-printed form, where the pre-printed form having a plurality of data entry blanks occupying predefined positions on the pre-printed form. The system performs the following: displaying a graphical replica of the pre-printed form; displaying a plurality of data fields on the graphical replica, the data fields being positioned in the same relative positions to each other as the plurality of blanks on the pre-printed form; accepting data into the data fields; formatting the data in accordance with one or more specified data formats; and storing the data in a data management system.

Implementations of the system can perform one or more of the following. The system imports data from a third party application into the data management system. If the third party application has a custom name extension, the system renames the third party application into a known name extension. The system can create new tables in the data management system and import field by field the data from the third party application into newly created tables of the data management system. The system can copy a payer's information from one row of an imported table into a tax payer table in the data management system. The system can also copy a payee's information from one row of an imported table into a tax payee table in the data management system. The preprinted form can be a tax form, including Form 1099s, Form W-2, Form W-2G, Form 1042S, Form 1098, Form 5498 and Form 8027. The system can generate reports or exporting data. The system can print the graphical replica of the pre-printed form with the formatted data as an output.

Advantages of the invention may include one or more of the following. The system eliminates many inconveniences associated with the filing of federal, state, local, and foreign W2 tax forms in accordance with the tax laws. The system reduces error in and the cost associated with the filing of tax forms. Additionally, the system reduces or eliminates the need for hard copies of all or virtually all intermediate tax reporting forms, and thereby to realize savings in paper, time, and cost.

The system provides a mirror of the actual tax forms over the data entry areas so that users can visually correlate the data with the form being used. The system flexibly supports different forms and multiple forms can be opened at once. Information from one form (such as payer's names and its payees) is carried from one form to another form without the need to select, cut and paste the data. The payer's information form always displays side by side with all tax forms for convenience and easy lookup. Switching from one payer to another for tax filing by easy selecting the payer from the payer's information form. The list of payees that under one payer are divided into two separated lists for faster processing (list of tax unfiled payees, and finished filed payees list in the payer's information form). The system provides an automatic selection of the next payee in payee lists of payer's information form and display that payee's tax information. The user can save the current payee's tax record by clicking the SAVE button from the bottom of payer's information form. The system displays different 1096 tax information for an existing payer when the user selects different 1099 categories on the 1096 tax form (W2G, 1099A, 1099B, etc.). Missing information in creating new payer will be flashing to alert user that those information need to be filled in (Address, City, State, Zip Code, Federal ID or SSN). In order to reduce errors usually occur during entering tax figures in W2 tax form, amount in box 1 (wages, tips) is checked to be sure that it is equal to total of box 3 and box 7 (Social Security wages+Social Security tips) minus any pension plan deductions. Additionally, the system checks for the social security taxable threshold amount for a tax year. The system allows the user to select any connected printer that would be used for tax printing regardless that printer is set as default or not. The system also provides flexible tax printing form. For example, it allows a user to select all categories from one place before printing tax (Tax type, tax paper format, tax copies, form alignment, etc.).

When a payer is selected along with its payees with W3 option, a summary of W3 tax information for that payer will be displayed to show the user a snapshot of total tax amount filed, total W2 forms filed, among others. The same information displays for 1096 tax selected with any 1099 tax category. The user can print 1096 tax correction for a payer by selecting: Correction check mark, one or more payees (that need the correction), type of 1099 category, and 1096 tax checkmark. The system then generates (calculates) 1096 information for those payees that need the correction. Each tax form is accompanied by Payers Information, which allows company to be selected. The upper box lists all payees whom tax forms have been completely filed but not yet printed. The second box lists all those whom forms have been completely filed and already printed for the tax forms that are currently appearing.

Moreover, the above objects and advantages of the present invention are illustrative, and not exhaustive, of those which can be achieved by the present invention. Thus, these and other objects and advantages of the present invention will be apparent from the description herein or can be learned from practicing the invention, both as embodied herein and as modified in view of any variations which may be apparent to those skilled in the art.

### BRIEF DESCRIPTION OF THE DRAWINGS

FIG. 1 shows an exemplary process for capturing payee data.

FIG. 2 illustrates an exemplary process for capturing payer data.

FIG. 3 shows an exemplary process for generating reports or exporting data

FIG. 4 shows an exemplary process for importing data.

FIG. 5 shows an exemplary process for generating tax forms.

FIG. 6 shows an exemplary tax form printing process.

FIG. 7 is a diagram illustrating relationships in a tax form database

FIG. 8 shows an environment for processing computerized tax transactions.

FIGS. 9-14 show exemplary user interface designs for a computerized tax transaction system.

### DESCRIPTION

Referring now to the drawings in greater detail, there is illustrated therein structure diagrams for the tax transaction system and logic flow diagrams for the processes a computer system will utilize to complete various tax transactions. It will be understood that the program can be run as stand-alone software directly installed on a computer or can be run on a computer that is capable of communication over a network, as will be more readily understood from a study of the diagrams. The tax transaction system can process payer and payee information, and a user selects whether payer or payee forms are to be used. The user can be a taxpayer or a tax return preparer institution, such as a professional tax preparation company, an accounting firm, or an individual accountant.

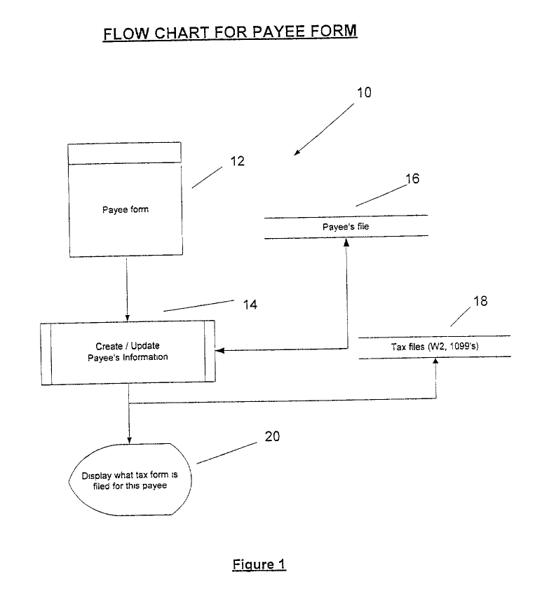

FIG. 1 shows an exemplary process 10 for capturing payee data. First, payee form information is retrieved and displayed (step 12). Next, the process 10 allows the user to create and update a particular payee's information (step 14). The payee's file is updated (step 16) and tax files are generated (step 18). The process then displays the tax forms that need to be filed for the payee (step 20). Tax data can be processed by performing the appropriate tax computations. Non-limiting examples of appropriate tax computations include: addition, subtraction, multiplication to determine the taxpayer's gross income, and relevant deductions. The tax forms can be prepared with respect to the particular taxing authorities. For example, if the taxing authority is the IRS, the electronic tax return will correspond to the appropriate federal tax form such as W-2 or 1099 forms

In one embodiment, payees are created under a particular payer. One payee's information can be created in multiple payers (A person can have more than one employer.) Information is updated in this payee form will also affect all tax forms associated with that payee. In this embodiment, below the payee's form, an informative form displays what kind of tax forms has been processed for this particular payee

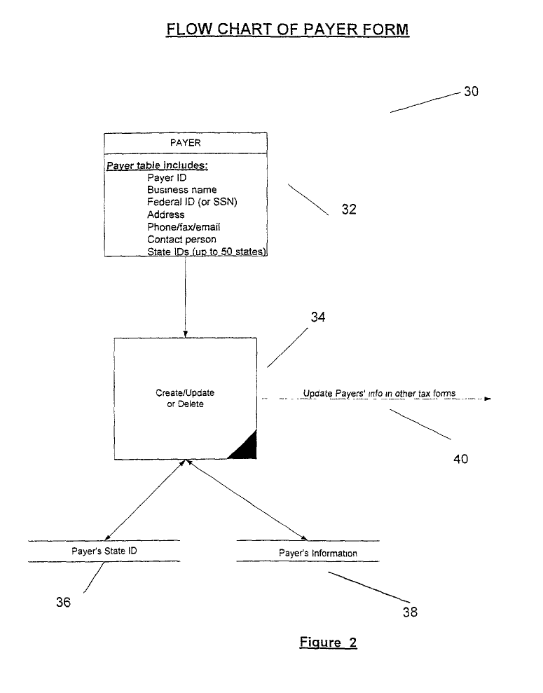

FIG. 2 illustrates an exemplary process 30 for capturing payer data. Data relating to a payer is accessed (step 32). For a new payer, the user can either import existing data for the payer or enter data manually. Since re-entering data yearly can be a time-consuming chore, users can import data from other commonly used W2 and 1099s software. Importing data can be done in several easy steps: 1) Go to the Menu bar, select Maintenance, click Import; and 2) Click on the source in which the data is to be imported from. Data is entered into a payer table that includes payer identification, business name, federal identification (FID or SSN), contact information, and relevant states, among others. The information on the payer can be created, updated or deleted (step 34). Operations in step 34 can update the payer's state identification (step 36) or the payer's information (step 38). Additionally, the operation in step 34 can update other tax forms (step 40).

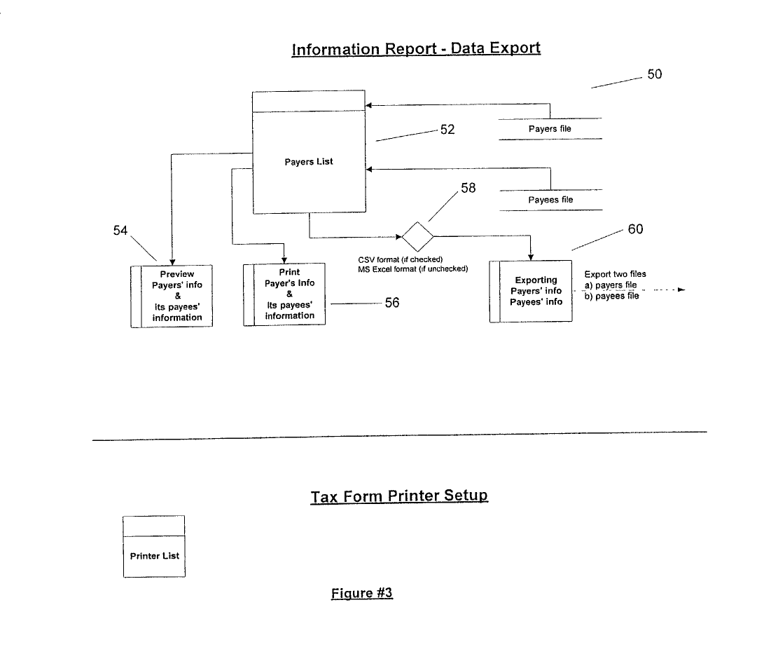

FIG. 3 shows an exemplary process 50 for generating reports or exporting data. The process 50 generates a payer's list (step 52) by examining a payer file and payee file. Next, if requested, the process 50 generates a preview of payer and payee information (step 54). Additionally, if requested, the process 50 prints reports on payer and payee information (step 56). Alternatively, the process checks whether the user desires to export data (step 58). If so, the process exports a payer's file and a payee's file, among others (step 60).

In one embodiment, payers and payees' information (Name, Identification number, address, telephone/fax) can be printed out as reports. They also can be exported to external folders in two different formats: Text file with comma separated (CSV), and MS Excel spread sheet. The user has two choices to select either one payer's and its payees' information to preview, print and/or export or select all payers' and their payees' information, for example.

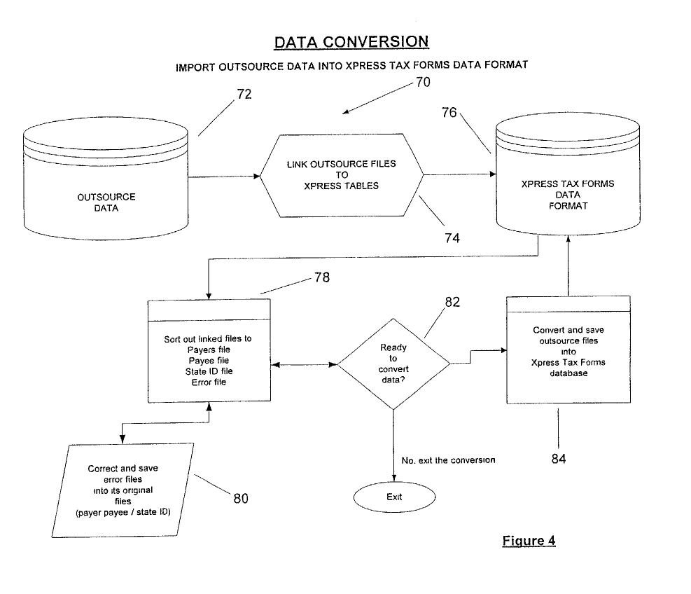

FIG. 4 shows an exemplary process 70 for importing data First, the user supplies outsource data or external data (step 72). Next, the outsource data is linked to one or more tables (step 74). A database is generated with data linked based on the data format (step 76). The process 70 then sorts the linked files to a payer file, a payee file, a state identification file and an error file (step 78). If an error exists, the process displays a list of errors (step 80). From step 78, the process 70 determines whether the user is ready to convert the data (step 82). If not, the process exits. Alternatively, if the user is ready to convert, the outsource data is converted into one or more tables containing the properly formatted data (step 84), and the data is stored in the database generated in step 76.

In one embodiment, the data conversion module allows users who use W2/1099 lax software other than the current software to convert their tax data from those software databases into an intermediate database format. Other database formats include: dBase (3.0, 4.0, 5.0), Paradox (*.db), MS FoxPro (*.dbt), MS FoxPro v. 3.0 (*.dbc), text file (*.txt, CSV), and MS Excel, MS Access 97, and MS Access 2000 formats. In this embodiment, the user can select the existing W2/1099 Generator software from the W2/1099 software list that needs to convert data from The user can select the directory/folder (location) where the outsource data resides and select the directory/folder (location) where the Xpress Tax Forms database resides (W2001.mdb). The files from outsource database is linked to the Xpress Tax Forms database. These linked tables are copied to temporary working tables, the links are then deleted The system sorts out the temp tables into other four temporary tables: Payer, Payee, State ID, and Error tables and displays in grids four tables (payers, payees, payer errors, and payee error tables). Before posting temp data into a database, if there is still data in error table the system asks if user wants to continue correcting or deleting those data and posts these temporary working payer, payee, and state ID tables into main payer, payee, and state ID tables in Xpress Tax Forms database. The system deletes the temp tables, clean up and compact database when finish the data conversion. The system selects payer ID in payer grid, its payees' records will display in payee grid (same action for payer errors and payee errors grids).

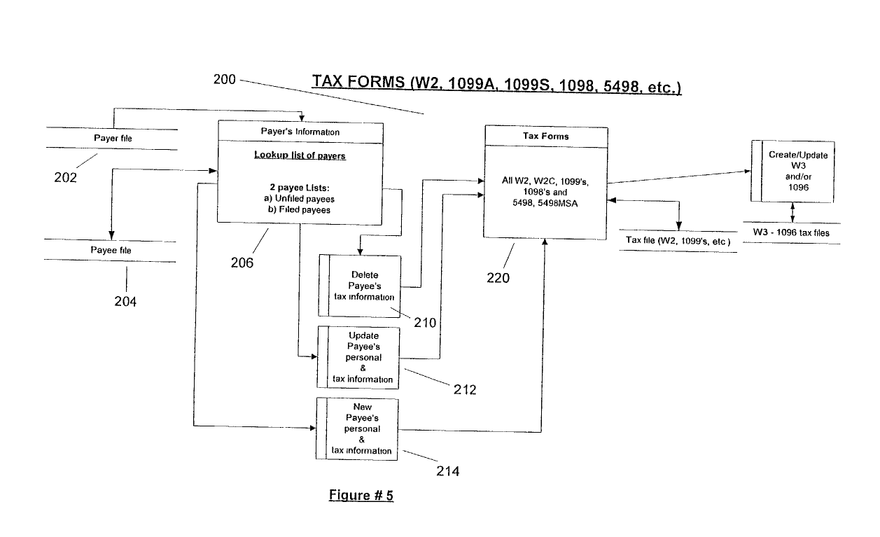

FIG. 5 shows an exemplary process 200 for generating tax forms. First, data from a payer file is retrieved (step 202). Next, the process looks up payee information (step 204). Based on the retrieved information, the process 200 generates an unfilled payee list and a filed payee list. The payee's tax information can be deleted (step 210), updated (212), or added (step 214). From steps 210-214, one or more tax forms are generated (step 220).

In one embodiment, the payer's information is displayed along with every tax form. In the payer's information form, there is one lookup payer list and two lists of payees: a) List of payees that have not YET filed any tax or filed some but not finished ALL fields that required to; and b) List of payees that have finished ALL fields in tax form that is required to file. To distinguish the two lists, the font color in the top list is black; however, the font color of the second list is in color (green.)

Payees lists can be sort in three ways, by: a) Last Name, b) First Name, or c) Social Security number. When a payee record is selected in the Payer's Information form (either in the top unfinished list or in second list), that payee's tax information will be displayed in the tax form. This tax information can be updated or deleted through some functions exist on the Payer's Information form.

There are three functions in the Payer's Information form: a) Delete, which allows user to delete an existing payee's tax information by remove all tax data, an “X” is added to the VOID field; however, that payee's personal information (name, SSN, address, etc.) is still intact. And the DELETE button is read as UNDELETE in red color.

A second function is a “New” function that creates new payee of a particular payer inside the tax form (instead of creating new payee through payee form). A third function is a “Save” function: if in the process of creating new payee in tax forms, it will save payee's tax information in tax files and payee's personal information in payee's file and in tax forms also. If not in process of creating new payee in tax forms, it will save any changes made in tax form for that payee. Afterward, the focus is moved to the next payee in the list (either the top list or in the second list), and its tax information will display in the tax form for modification.

In one implementation, to CREATE a new tax form for employees whom already have their employees information stored:

1) To get to the form needed, either click on the icon representing that form or go to the menu bar, select TAX FORMS and scroll down and click on the tax form to be created.

2) In the PAYER'S INFORMATION box, scroll down and click on the employer/payer name in which the form will be created under.

3) Next, click on the name of the employee whose tax information is about to be entered. All pre-established information should now appear in the correct box on the tax form. Although a state ID may have already been entered in the company 's data profile. It will not automatically appear until that state abbreviations have been manually put in on the form.

4) Enter in any remaining information and save the data.

5) Repeat this process with other employees and companies.

To CREATE a tax form without any prior employee information stored:

1) To get to the form needed, either click on the icon representing that form or go to the menu bar, select TAX FORMS and scroll down and click on the tax form to be created.

2) In the PAYER'S INFORMATION portion of the screen, scroll down and click on the company/payer name in which the form will be created under (this is in the upper right hand corner under the description of employer/payer.)

3) In the left section of the PAYER'S INFORMATION box, click NEW to generate a new payer.

4) Enter all necessary data in the correct designated areas.

5) When complete with entering that person's information, save the data.

6) Repeat this process with other employees and companies.

For W3s and 1096:

1) Click on the icons for either W3 or 1096 depending on the form needed OR go to menu bar, go to the tab for Tax Forms, scroll down to the form needed, and click once on that form.

2) Select the payer.

3) Click on the tax form listed within the 1096 form, which the payees for that payer have been created (e.g. 1099 Misc. or 1099DIV). All related information will appear.

This embodiment calculates total W2s in W3 for payer as follows: if the tax form displaying is W2, right before a new payer is selected in the lookup list of Payer's information form for entering W2 data, all W2 tax information for the previous payer will be calculated by adding all W2 tax information of its payees who has been entered all information required (whose name is in the second list). Then, will check the W3 file to see if W3 tax information for this payer exists in order to have proper action (create new W3 record for this payer or update its current W3 information.). The embodiment also calculates total 1099's (W2G or 1098's or 5498's) in 1096 for payer. The logic is the same as in the calculation of total W2 in W3 tax.

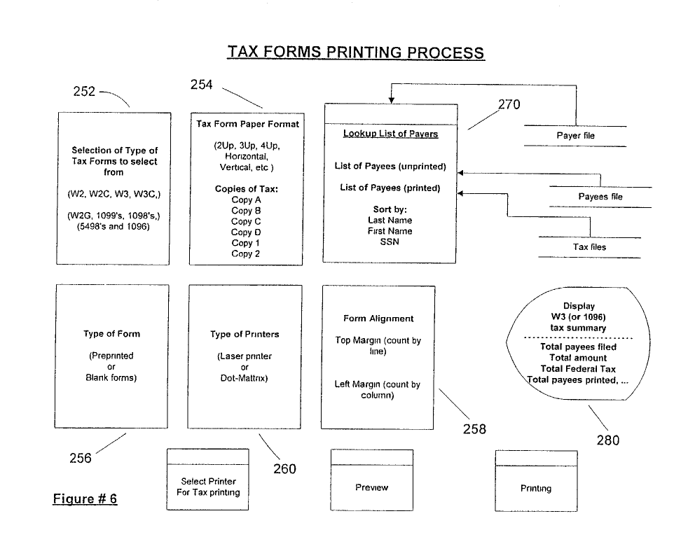

FIG. 6 shows an exemplary tax form printing process 250. First, the user selects a type of tax form, for example W2, W2C, W3, or W3C, among others (step 252). Next, a paper format is selected (step 254). A form type is designated (step 256), a form alignment is specified (step 258), and a printer is selected (step 260). Based on the selections, the process looks up a list of payers (step 270) by examining the payer file, the payee file, and other tax files. The process can generated a list of payees that have not been printed, or it can list the payees. Additionally, step 270 can sort based on first or last name or social security number. The information can also be displayed for the user to review (step 280). The system can electronically file the electronic tax forms with the taxing authorities. In practicing the invention, the taxing authority can be the IRS, or a state, local or foreign taxing authority.

In one embodiment, the system generates a lookup list of payer: a) Payees that completely filed and not yet printed; and b) Payees that completely filed and already printed.

Pseudocode to preview or print tax forms is as follows:

Look up for a payer

Its payees will display in the first list (completely filed and not yet printed.)

Select one or more payees that need to print (or preview) by click on payee's record (click again on a selected record to deselect that record.)

Select the type of tax that needs to print (W2, 1099A, etc.)

Select the tax form paper format (2Up, 3Up, etc.)

Copies of tax should be printed (copy A, copy B, etc.)

Type of form paper (preprinted paper or blank paper.)

Select a printer used for printing tax forms (laser printer or dot-matrix)

If necessary, set the top margin (by move down half a line, one line, one and a quarter lines, one and a half lines or two lines.)

Set the left margin (by move to the right one column, two columns, three or four columns.)

On the left lower corner of the form, a message shows the number of payees that payer has; the number of payees that had filled out completely tax form; and the number of payees that are selected to be printed. If type of tax selected is W3 or 1096, a tax summary will pop up on the right lower corner showing the number of payees, the amount, and the number of reports printed. W3 and/or 1096 tax forms of a payer can be printed only when other tax forms have been printed for its payees.

For printing any 1096 correction that is made after issuing 1099's, W2G, 1098's or 5498's, the system performs the following:

Select the payer that has made correction from the Lookup List of Payer

Select 1096 in Type of Tax frame

Make sure the Correction is checked

Highlight payee(s) in the second payees list, and click Preview to view correction on the screen, or click Print to print out (with selecting other proper options: 3Up, Copy A, etc.)

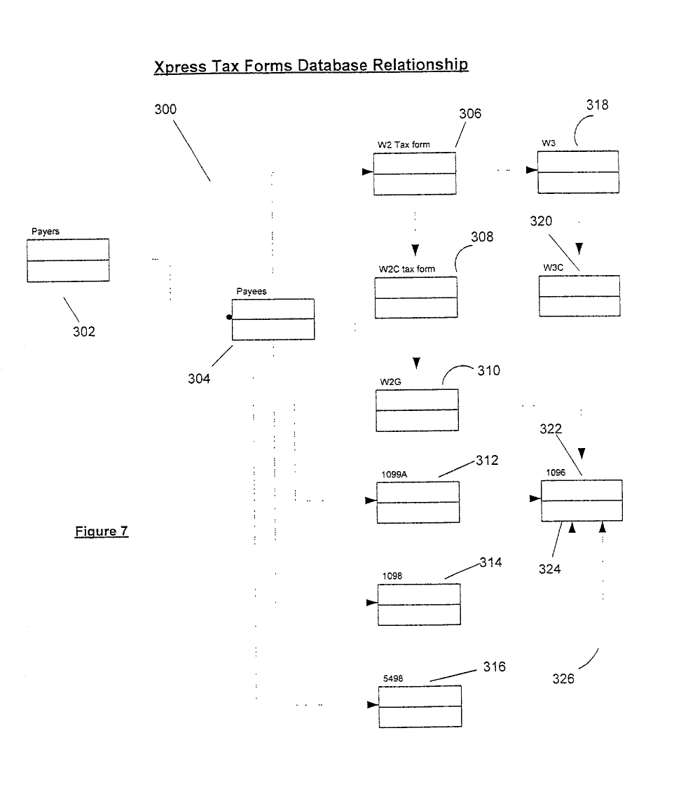

FIG. 7 is a diagram illustrating database relationships in a tax form system. A payer file 302 is accessible to a payee file 304. The payee file 304 is linked to a W2 tax form file 306. The W2 tax form 306 in turn is linked to a W2C tax form file 308, a W3 tax form file 318 and a W3C tax form file 320. The payee file 304 is also linked to a W2G file 310, a 1099A file 312, a 1098 file 314 and a 5498 file 316, which in turn are linked to a 1096 file 324.

The Payer file stores business information. The Payee file stores employee's (contractor's) information. The W2 file stores payee's annual income information. The W2C file stores correction of payee's annual income information. The W3 file stores total W2 information for one payer. The W3C file stores correction for W2C tax form. The W2G file stores tax form for filing gambling money, while the 1099 file stores information on compensation that business pays for contractor(s) regarding tax forms 1099B, 1099C . . . 1099S. The 1096 file stores total of related 1099, W2G, 1098, and 5498.

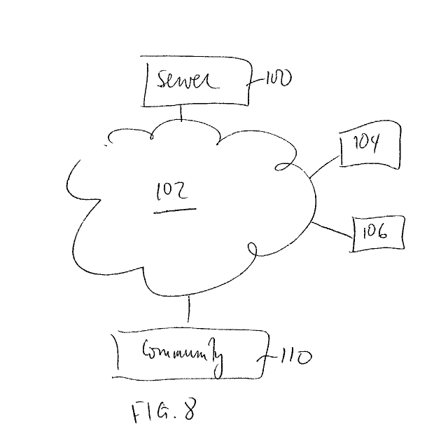

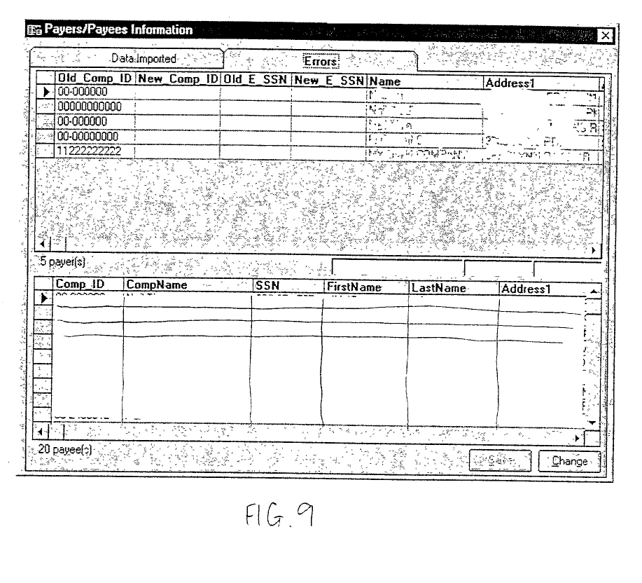

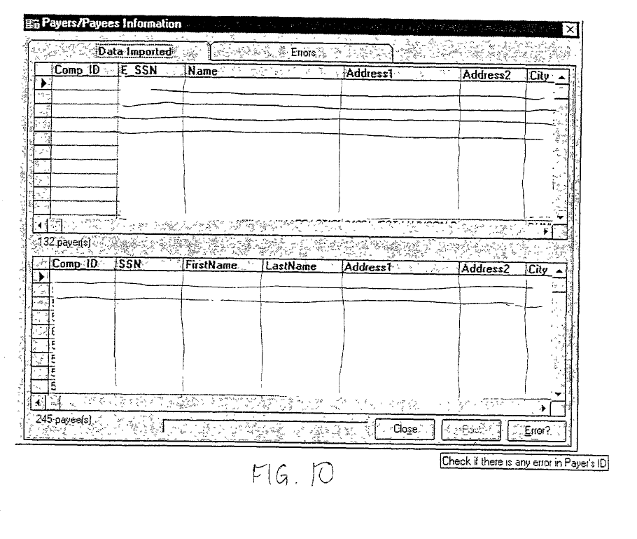

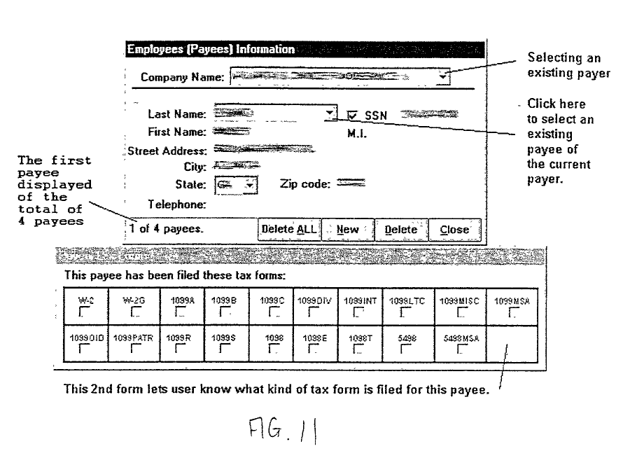

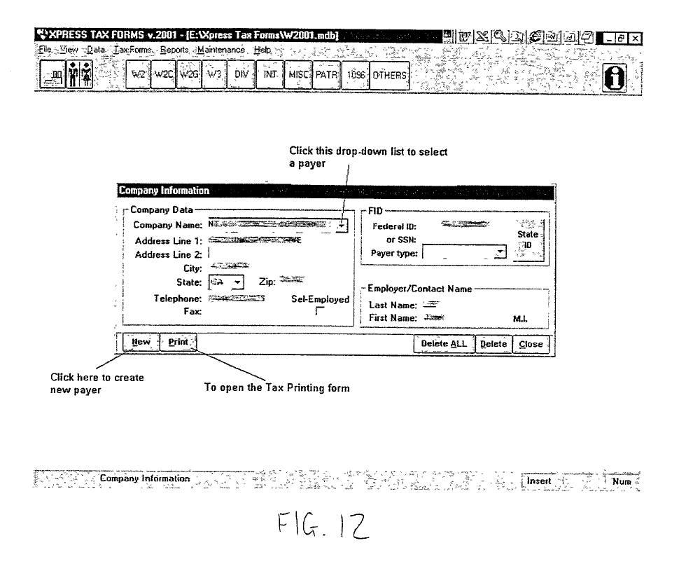

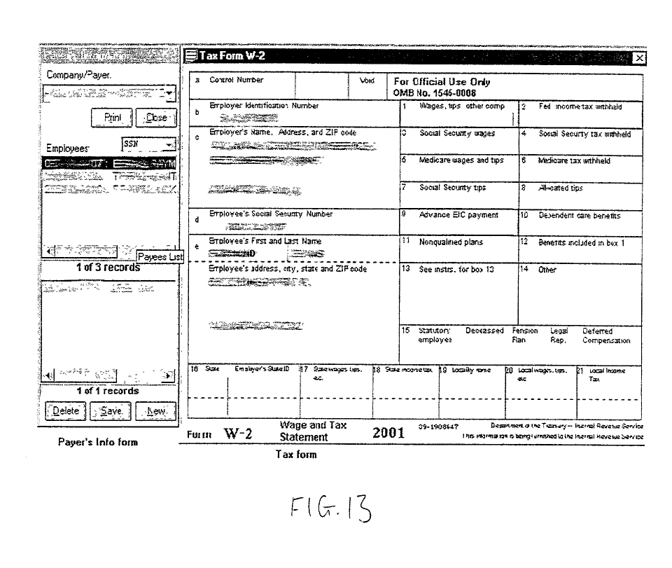

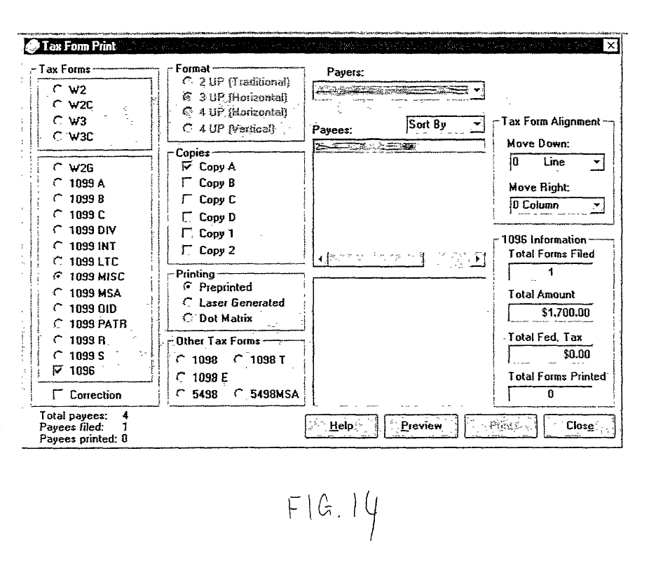

FIG. 8 shows an environment for processing a computerized tax form transaction. A server 100 is connected to a network 102 such as the Internet. One or more client workstations 104-106 are also connected to the network 102. The client workstations 104-106 can be personal computers or workstations running browsers such as Netscape or Internet Explorer. The personal computers or workstations can include a processor connected to memory, display, input devices and data storage devices.

With the browser, a client or user can access the server 100's Web site by clicking in the browser's Address box, and typing the address (for example, www.vilas.com), then press Enter. When the page has finished loading, the status bar at the bottom of the window is updated. The browser also provides various buttons that allow the client or user to traverse the Internet or to perform other browsing functions.

An Internet community 110 with one or more companies, service providers, manufacturers, or marketers is connected to the network 102 and can communicate directly with users of the client workstations 104-106 or indirectly through the server 100. The Internet community 110 provides the client workstations 104-106 with access to a network of tax specialists such as accountants and tax attorneys. Additionally, the Internet community 110 also provides access to a variety of supporting members such as escrow service firms and other service providers, such as printers or archival firms, among others.

Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 100 supports a tax transaction portal that provides a single point of integration, access, and navigation through the multiple enterprise systems and information sources facing knowledge users operating the client workstations 104-106 The portal can additionally support services that are transaction driven. Once such service is advertising each time the user accesses the portal, the client workstation 104 or 106 downloads information from the server 100. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Additionally, the portal offers contents and forums providing focused articles, valuable insights, questions and answers, and value-added information about related issues, including information on tax issues.

Other services can be supported as well. For example, a user can rent space on the server to enable him/her to download application software (applets) and/or data—anytime and anywhere. By off-loading the storage on the server, the user minimizes the memory required on the client workstation 104-106, thus enabling complex operations to run on minimal computers such as handheld computers and yet still ensures that he/she can access the application and related information anywhere anytime. Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee.

The server 100 allows a consumer to log onto a computerized tax transaction system over a network and automates the steps required to complete various tax forms. The above system allows a party to complete a tax form transaction from beginning to end using one centralized resource. This makes the tax preparation process easier to understand for the consumer and allows them to control and keep track of progress. The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of processing data intended to be entered into a pre-printed form, the pre-printed form having a plurality of data entry blanks occupying predefined positions on the pre-printed form, comprising:
displaying a graphical replica of the pre-printed form;
displaying a plurality of data fields on the graphical replica, the data fields being positioned in the same relative positions to each other as the plurality of blanks on the pre-printed form;
accepting data into the data fields;
formatting the data in accordance with one or more specified data formats; and
storing the data in a data management system.

2. The method of claim 1, further comprising importing data from a third party application into the data management system.

3. The method of claim 1, wherein the third party application has a custom name extension, further comprising renaming the third party application into a known name extension.

4. The method of claim 1, further comprising creating new tables in the data management system and importing field by field the data from the third party application into newly created tables of the data management system.

5. The method of claim 1, further comprising copying a payer's information from one row of an imported table into a tax payer table in the data management system.

6. The method of claim 1, further comprising copying a payee's information from one row of an imported table into a tax payee table in the data management system.

7. The method of claim 1, wherein the pre-printed form is a tax form.

8. The method of claim 1, wherein the pre-printed form is one of Form 1099, Form W-2, Form W-2G, Form 1042S, Form 1098, Form 5498, and Form 8027.

9. The method of claim 1, further comprising generating reports or exporting data.

10. The method of claim 1, further comprising printing graphical replica of the pre-printed form with the formatted data.

11. A data processing system for processing data intended to be entered into a pre-printed form, the pre-printed form having a plurality of data entry blanks occupying predefined positions on the pre-printed form, comprising:
means for displaying a graphical replica of the pre-printed form;
means for displaying a plurality of data fields on the graphical replica, the data fields being positioned in the same relative positions to each other as the plurality of blanks on the pre-printed form;
means for accepting data into the data fields;
means for formatting the data in accordance with one or more specified data formats; and
means for storing the data in a data management system.

12. The system of claim 11, further comprising means for importing data from a third party application into the data management system.

13. The system of claim 11, wherein the third party application has a custom name extension, further comprising means for renaming the third party application into a known name extension.

14. The system of claim 11, further comprising means for creating new tables in the data management system and means for importing field by field the data from the third party application into newly created tables of the data management system.

15. The system of claim 14, further comprising means for copying a payer's information from one row of an imported table into a tax payer table in the data management system.

16. The system of claim 14, further comprising means for copying a payee's information from one row of an imported table into a tax payee table in the data management system.

17. The system of claim 11, wherein the pre-printed form is a tax form

18. The system of claim 11, wherein the pre-printed form is one of Form 1099, Form W-2, Form W-2G, Form 1042S, Form 1098, Form 5498, and Form 8027.

19. The system of claim 11, further comprising means for generating reports or exporting data.

20. The system of claim 11, further comprising means for printing graphical replica of the pre-printed form with the formatted data.
